(19) United States
(12) Patent Application Publication
(10) Pub. No.: US 2003/0053272 A1
(43) Pub. Date: Mar. 20, 2003

(54) Electronic safety loop

(76) Inventors: Ralf Hetzer, Kiel (DE); Mike Kwasniewski, Schleswig (DE); Marcus Saage, Kiel (DE); Uwe Schmidt, Breitenberg (DE); Lutz Michael Wagner, Kiel (DE); Jorg Zessin, Ascheberg (DE)

Correspondence Address: Lawrence P. Kessler, Patent Department, NexPress Solutions LLC, 1447 St. Paul Street, Rochester, NY, 14653-7103, US

(21) Appl. No.: 10/233,123

(22) Filed: Aug. 30, 2002

(30) Foreign Application Priority Data
Sep. 6, 2001 (DE) 101 43 816.8

(51) Int. Cl. H02H 7/00

(52) U.S. Cl. 361/1

(57) ABSTRACT

An electronic safety loop for the switching of safety-related devices of a printing press, which provides several safety switches for selective switching of the safety-related devices as a function of the accessibility of the safety-related devices by a person near the open housing of the printing press. The down time of the printing press is considerably reduced by these characteristics. In addition, the electronic safety loop increases personal safety.

### FIELD OF THE INVENTION

This invention relates in general to an electronic safety loop for switching of safety-related devices of a printing press.

### BACKGROUND OF THE INVENTION

Printing presses have a multitude of safety-related areas, in particular within the printing press. Moving parts, electrical voltages and motors within the printing press represent a danger for an operator with respect to the opening of flaps and doors of the printing press, when the operator approaches the interior. For this reason, the printing press is normally switched off before or during the opening of the interior. The printing press is normally switched off by the operator via the control mechanism. In addition, devices have been developed that automatically turn the printing press off when its flaps or doors are activated. One disadvantage of this feature is that once the printing press has been turned off, it takes some time before it is ready to operate again.

### SUMMARY OF THE INVENTION

The object of the invention is to safely switch a printing press and to increase the operating time of the printing press. The invention solves this task with an electronic safety loop for switching the safety-related devices of a printing press. This safety loop is provided with several safety switches for selective switch operation of the safety-related devices of the printing press by a person near an open or partially opened housing of the printing press as a function of the respective accessibility of the safety-related devices. The down time of the printing press is considerably reduced by these characteristics. Furthermore, the electronic safety loop increases personal safety. The safety switches can be triggered by activating the housing doors or flaps of the printing press. This characteristic saves activating the safety switches and increases the safety of the printing press, since the safety loop is triggered with each opening of the doors or flaps. To further increase safety, each safety switch can be connected to two signal lines that operate independently of one another.

The invention, and its objects and advantages, will become more apparent in the detailed description of the preferred embodiment presented below.

### BRIEF DESCRIPTION OF THE DRAWINGS

In the detailed description of the preferred embodiment of the invention presented below, reference is made to the accompanying drawings, in which:

FIG. 1 shows a schematic block diagram of an embodiment of the electronic safety loop for switching a safety-related device according to this invention;

FIG. 2 is a diagram showing the relationship of FIGS. 2a, 2b1, 2b2, and 2c;

FIG. 2a shows a flow chart of a portion of the self-test of the electronic safety loop according to this invention;

FIG. 2b1 shows the continuation of the flow chart from FIG. 2a;

FIG. 2b2 shows the continuation of the flow chart from FIG. 2b1;

FIG. 2c shows the continuation of the flow chart from FIG. 2b1;

FIG. 2d is a flow chart showing a portion of the self-test of the electronic safety loop according to this invention;

FIG. 3 is a flow chart showing a control run for testing the invention;

FIG. 4 is a diagram showing the relationship of FIGS. 4a and 4b;

FIG. 4a shows a portion of a flow chart for monitoring the hardware for deactivating devices of the electronic safety loop according to this invention;

FIG. 4b shows the continuation of the flow chart from FIG. 4a;

FIG. 5 is a flow chart showing a function of a CPU of the invention; and

FIG. 6 is a block diagram showing an embodiment of a branch of the electronic control loop according to this invention, for switching a motor of a printing press.

### DETAILED DESCRIPTION OF THE INVENTION

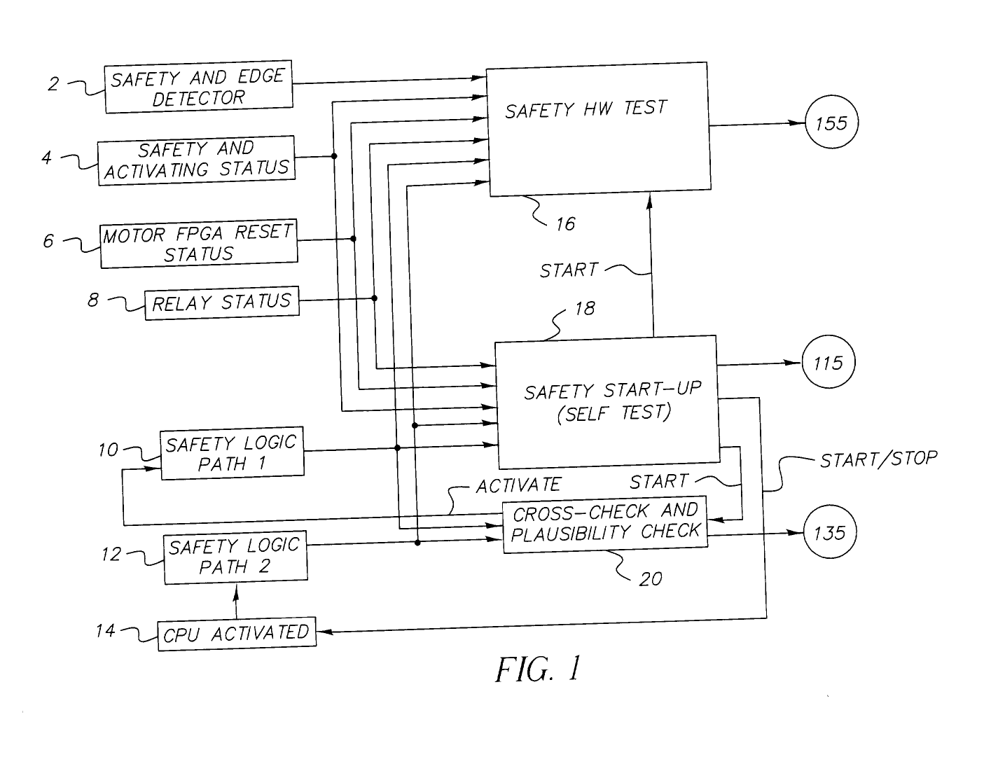

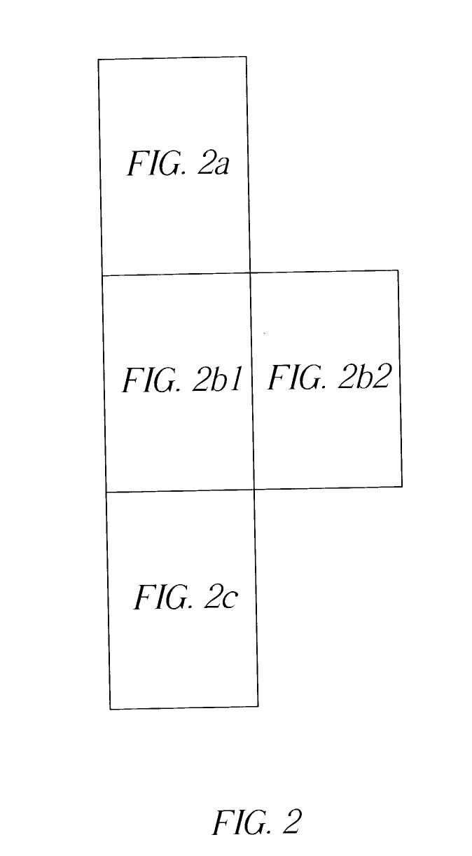

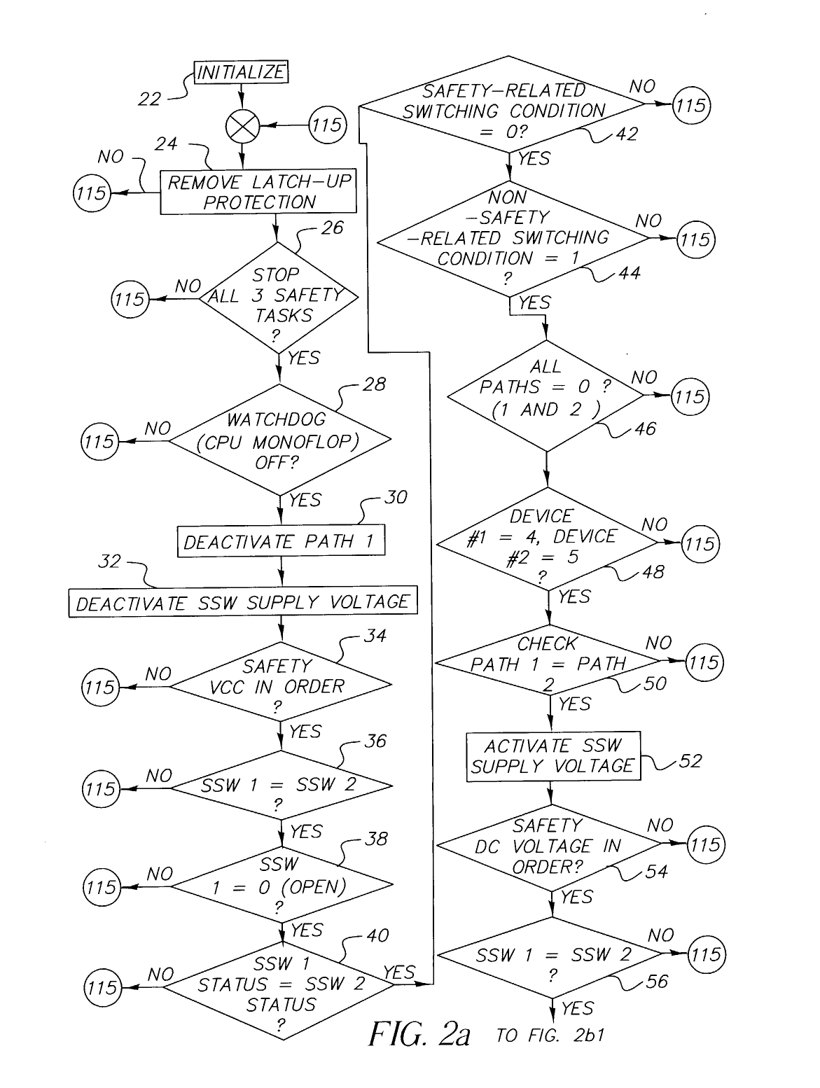

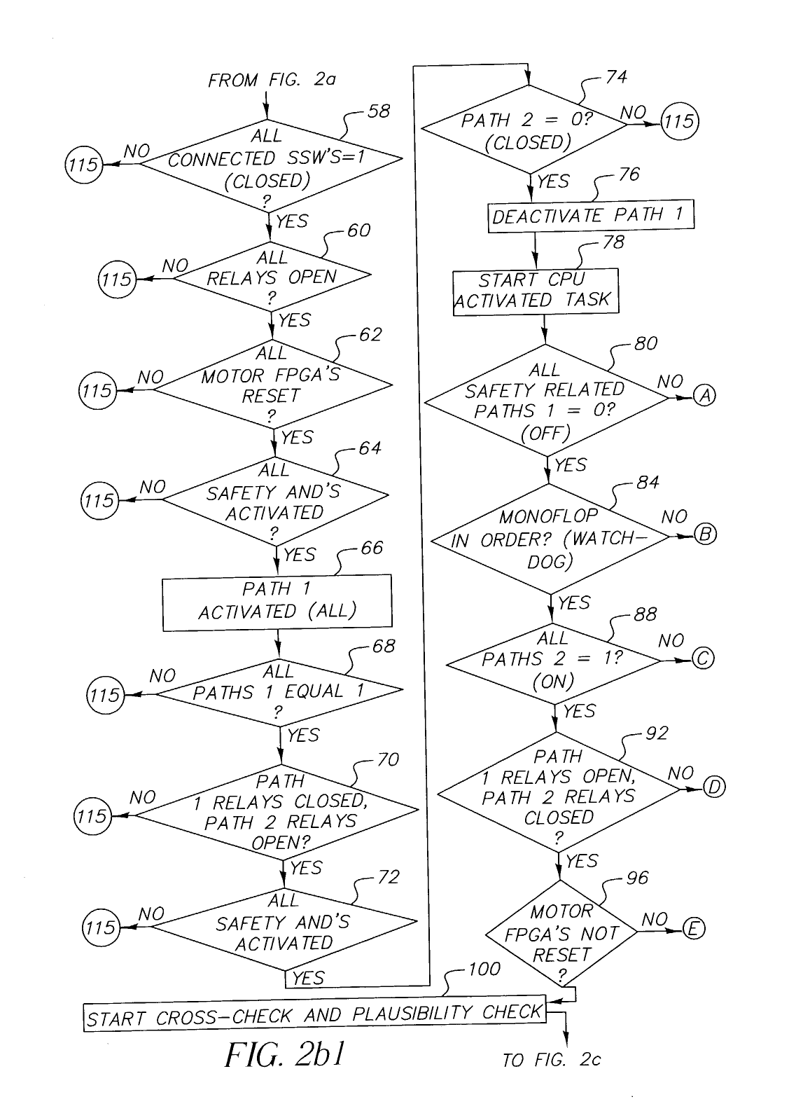

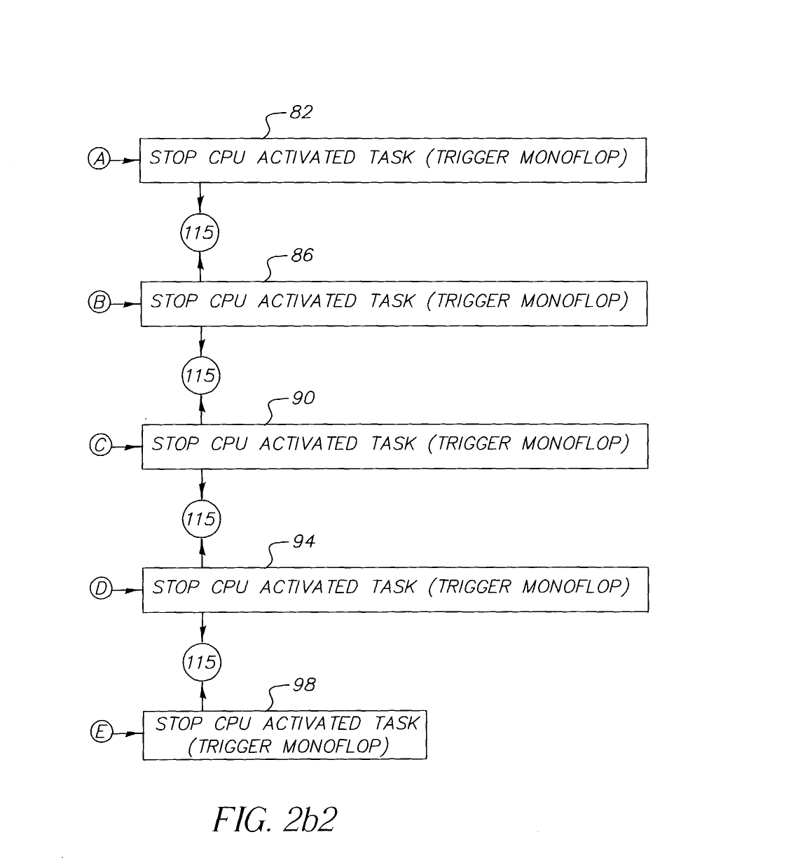

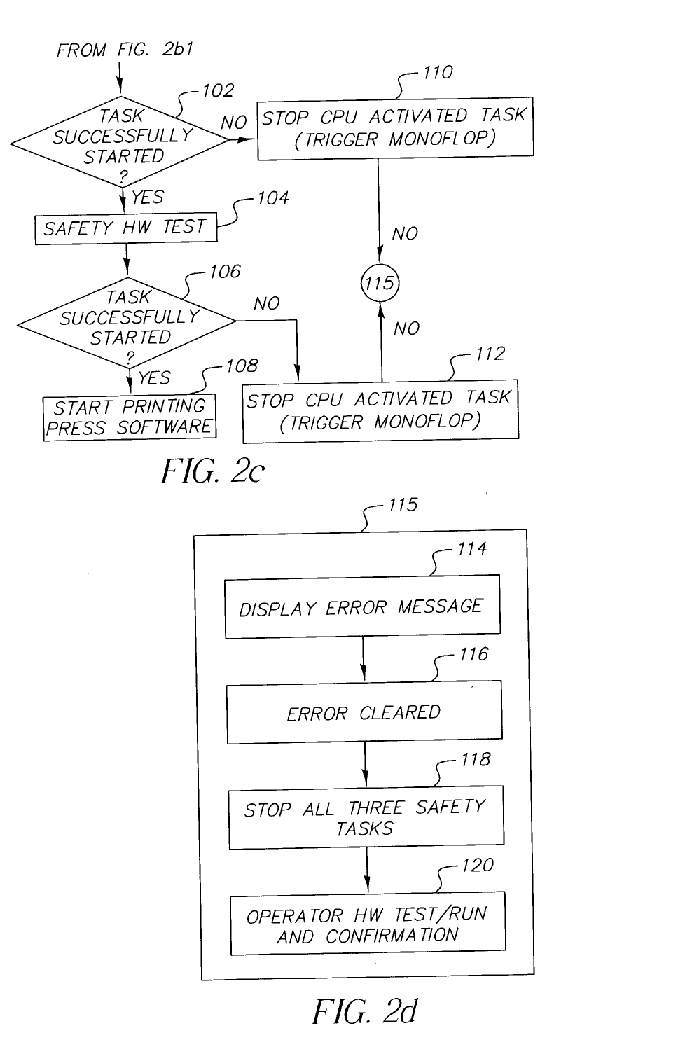

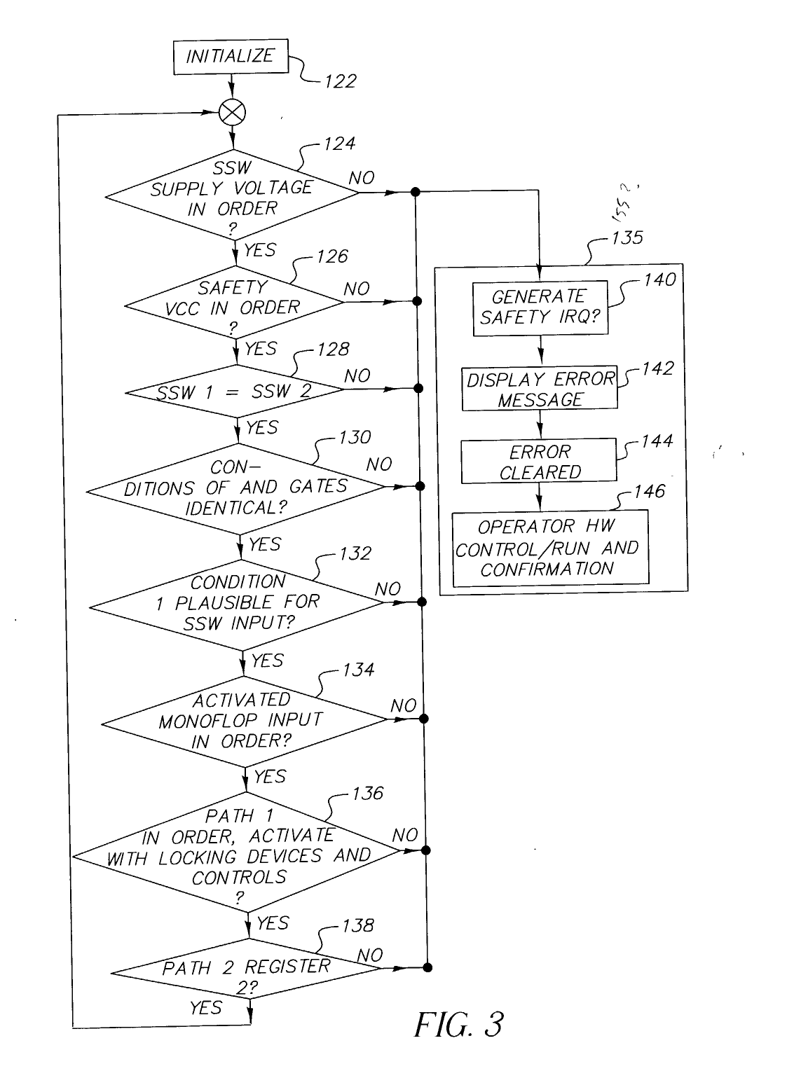

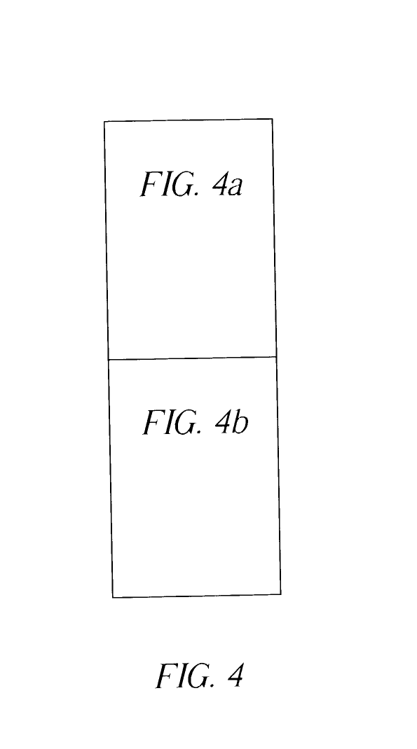

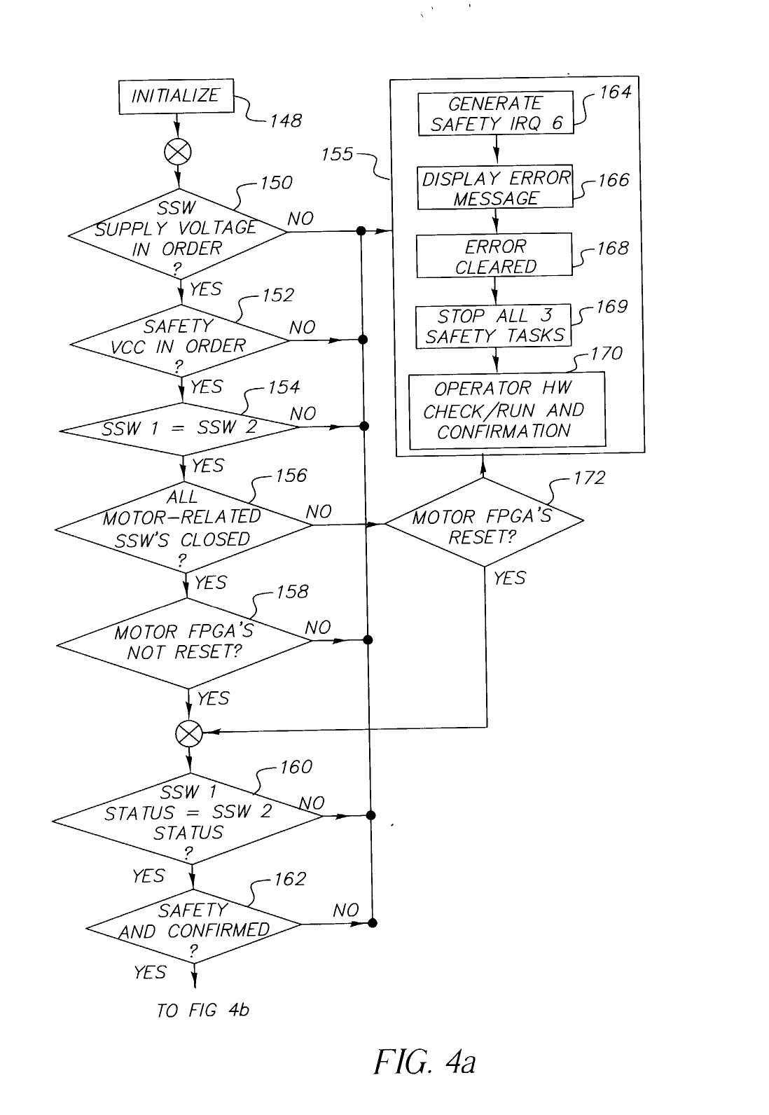

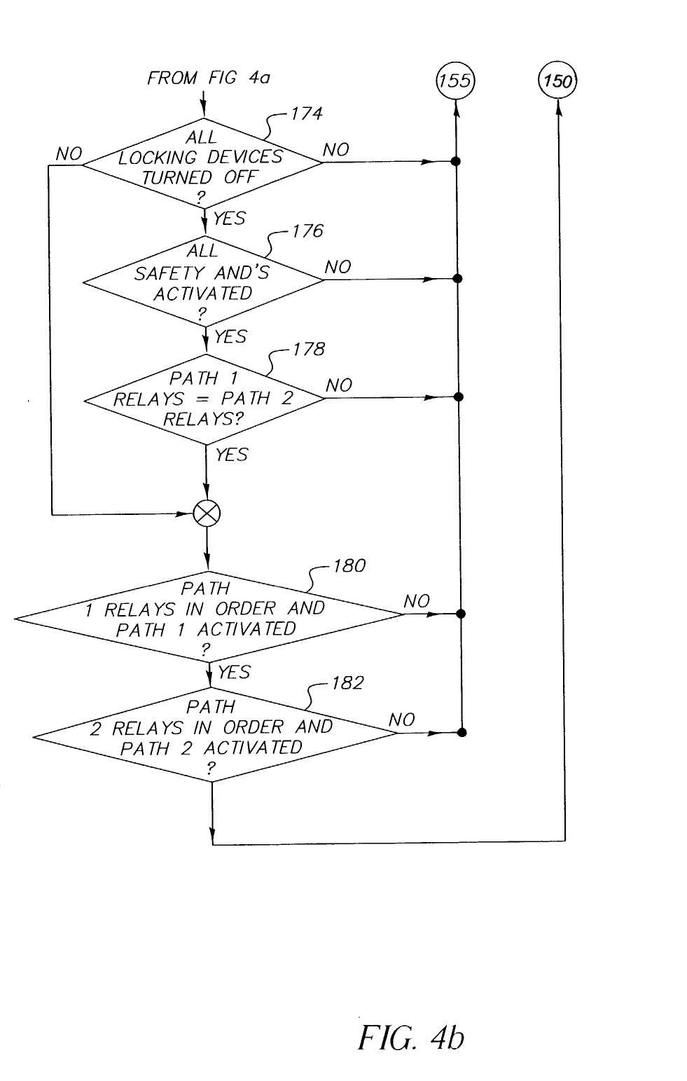

Referring now to the accompanying drawings FIG. 1 shows a block diagram of an embodiment of the electronic control loop, according to this invention, that is used to selectively switch various safety-related devices of a printing press. These safety-related devices include controls for, for example, the fuser unit, especially its heating lamps, the main drive, and the conveyor belt, particularly its high-voltage supply. The outputs of the blocks 2, 4, 6, and 8 lead to the safety HW test 16, the safety HW test shown according to flow charts of FIGS. 4a and 4b, and to the self-test or safety start-up 18 shown according to FIGS. 2a, 2b1, 2b2, 2c, and 2d. As can be seen, before the start-up of blocks 14, 16 and 20, block 18 is executed, which starts up after the start-up of the printing press. The outputs of a first safety logic circuit 10 (safety logic path 1) and a second safety logic circuit 12 (safety logic path 12) lead respectively to blocks 16 and 18 and to block 20, cross-check and plausibility check, in which the program run is executed according to FIG. 3.

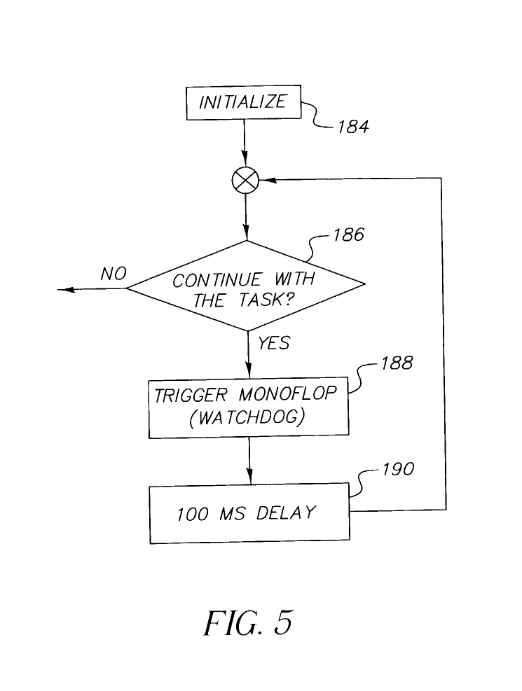

Blocks 16, 18, and 20 each have outputs, which, under certain conditions that are described below, lead to a selective deactivating of components of the printing press. Block 18 has further outputs that lead to a block 14 CPU activated, which is illustrated in detail in FIG. 5, to the block 16 and to the block 20, whereby a signal at one of the last two outputs of the block 18 leads to the initiation of the respective instructions of block 16 and 20. Block 20 has an additional output that leads to the first safety logic circuit (10), and a safety logic of the first safety logic path 1 is triggered or activated. Furthermore, a second safety logic path 2 is envisaged, which is controlled by a second safety logic circuit 12. The circuit block 14, CPU activated, is connected with block 12 of the second safety logic circuit of the second safety logic path 2.

FIG. 2a shows the program scan flow chart of the circuit block 18, the safety start-up or the self-test, which begins with the initialization in block 22. During this task conducted according to FIGS. 2a, 2b1, 2b2, 2c, and 2d, tests of the functionality of the hardware, in connection with the electronic safety loop, are conducted, as well as tests of the applied supply voltage, tests to check whether the safety switches for switching the safety-related devices of the printing press open by turning off the switching voltage, comparison of the signals of the first, safety logic path 1 and of the second safety logic path 2, test of the functions of the safety logic circuits and the switching of relays of the first safety logic path 1 and of the second safety logic path 2 for testing, whereby the relays of the safety-related devices of the printing press are switched. Block 18, the safety start-up (self-test), monitors the components of the printing press that the safety-related devices switch on and off, the AND gates, the reset of an FPGA (Field Programmable Gate Array) for controlling a motor of the printing press and the switching condition of the relays.

Subsequently, reference is made to FIGS. 2a, 2b1, 2b2, 2c, and 2d. Provided that a block 115 according to FIG. 2d sends a signal, then, according to FIG. 2a in block 24, a latch-up protection is removed, which blocks the operation in connection with the safety-related devices of the printing press. The test of whether all three safety tasks, the test of whether the CPU runs properly, CPU activated, the cross-check and plausibility check of the hardware according to block 20 and the hardware safety check according to block 16 have been stopped is conducted in Block 26. Only in this case is the test of whether the so-called Watchdog, a monoflop is turned off, i.e., that there is at least a low level at the output, conducted in block 28. If, however, one of the three safety tasks is activated at the time of the query, or the monoflop has a high level, a signal is transmitted to block 115 according to FIG. 2d, whereby in block 114, the operator at the control system device of the printing press sees an error message; in block 116, the error is cleared; in block 118, the three above-mentioned safety tasks are stopped, and finally, in block 120, one of the printing press operators confirms further operation.

If block 115 is successfully executed, the program run jumps back, and the self-test continues with the operating step of block 24. If the Watchdog is turned off according to block 28, the first safety logic path 1 is turned off and the supply voltage to a first safety loop 11 (SSW) is switched off or deactivated. All flaps or doors of the printing press that cover the accessible safety-related devices of the printing press are each equipped with a safety switch, so that with the opening and closing of the door or flap, the respective assigned safety switch is activated. Those safety-related devices of the printing press that are accessible to a printing press operator following the opening of the printing press and which pose a threat to him are turned off.

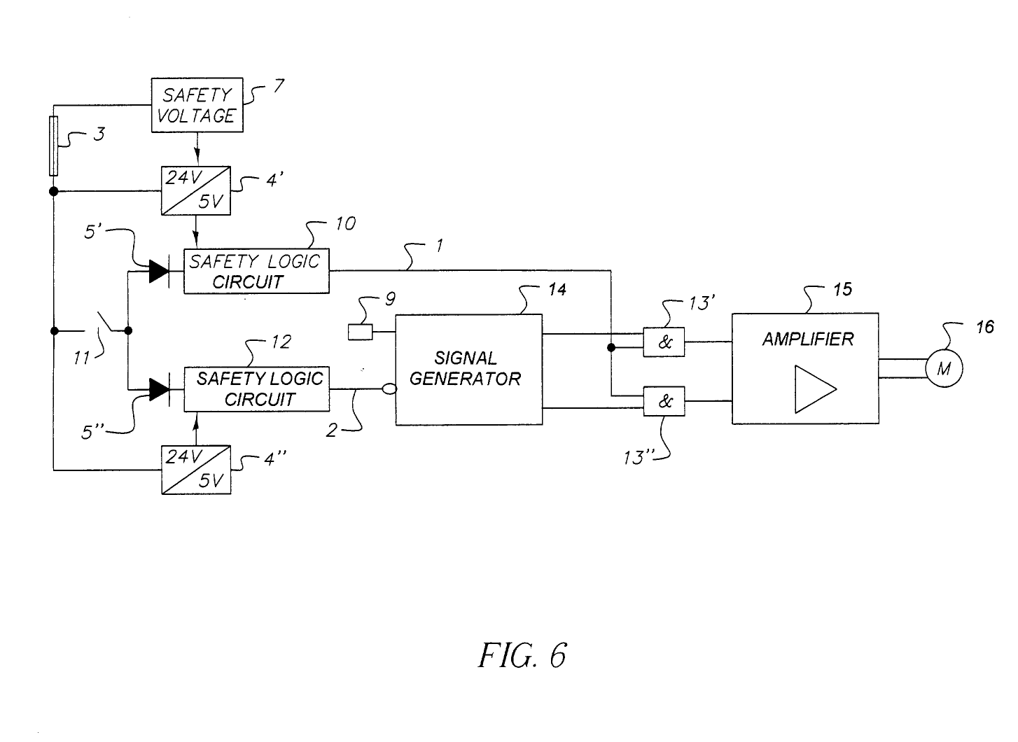

To this end, as described in the schematic diagram, block 18 is connected with block 10, the safety logic path 1 of the first safety logic path 1, and, via block 14, with block 12, the safety logic path 2 of the second safety logic path 2, whereby the first safety logic path 1 and the second safety logic path 2 control the switching of the relays. Subsequently, the safety voltage Vcc 7 is tested in the program run according to FIG. 2a. If the results of the test are negative, block 115 is executed, otherwise a test is conducted in block 36 to see whether the first safety switch 11 (SSW 1) and the second safety switch (SSW 2) have the same switching condition, and one in block 38 by turning off the switching voltage, to see whether the first safety switch 11 (SSW 1) opens. Only the first safety switch 11 (SSW 1) is depicted in FIG. 6; other safety switches are available in a similar manner, with one safety switch for each safety-related switching device.

The individual safety switches form the inputs of the first safety logic circuit 10 and the second safety logic circuit 12. For example, twelve safety switches each form twelve inputs of the first safety logic loop 10 and of the second safety logic loop 12, each of which has six outputs that form the safety logic paths for controlling the safety-related devices. Blocks 38, 40, 42, 44, 46, 48, 50, 52, 54, 56, 58, 60, 62, 64, 68, 70, 72, and 74 each send a signal to block 115 when the condition specified in the respective block is not met. If the respective condition is met, the respective next block in the program scan flow chart is executed. If the first safety switch 11 (SSW 1) is open, a test is conducted in block 40 to see whether the signal conditions of the first safety switch 11 (SSW 1) and the second safety switch (SSW 2) are identical, and then a test is conducted in block 42 to see whether the safety-related switching conditions are turned off and whether the safety-related devices of the printing press are turned off.

Furthermore, a test is conducted in this sequence in the program scan flow chart according to FIG. 2a in blocks 44, 46, 48, and 50, to see whether the non-safety-related switching conditions are turned on in the printing press; to see whether the first safety logic path 1 and second safety logic path 2 are turned off, and whether the first safety logic path 1 has the same switching condition as the second safety logic path 2. If such is the case, the supply voltage to the safety switches SSW is again activated, as illustrated in block 52.

Subsequently, an inspection is conducted in block 54 to see whether the safety voltage 7 V DC is properly applied. The safety voltage 7 (see FIG. 6) is 24 V in this case and is connected via a fuse 3 and the first safety switch 11 (SSW 1) with the switching block 10 of the safety logic path 1, and with the circuit block 12, the safety logic path 2, which activate or deactivate the respective safety logic path. A test is conducted in block 56 to see whether the switching conditions of the first safety switch 11 (SSW 1) and of the second safety switch (SSW 2) are the same.

The program scan flow chart is continued in FIG. 2b1. Block 58 checks to see whether the safety switches (SSW's) are closed, while block 60 checks to see if all the relays are open. For this purpose, the relays are assigned operational verifications contacts that are connected with the operating contacts of the relays and which check the switching condition of the relays. With electronic safety loops, relays are basically used to switch voltages. These are individually controlled by transistors, whereby each safety logic path 1, 2 contains one relay.

In order to achieve redundancy, the operating contacts of every two relays, which are arranged in individual safety logic paths 1, 2 are connected in series. The relays are provided with operational verification contacts to monitor the function of the relays. Block 62 checks whether all logic circuits (FPGA, Field Programmable Gate Array) of the motor 16 of the printing press are reset or whether a reset has been performed, and in block 64, whether all AND gates 13′, 13″ are deactivated. When the above-mentioned conditions have been met, the safety logic path 1 in block 66 is activated, in which a signal from block 18, the safety start-up (self-test) is transmitted to block 10, the safety logic path 1.

Subsequently, a test is conducted in blocks 68, 70, 72, and 74 to see whether the above-mentioned task has been carried out and whether the first safety logic path 1 is actually activated or whether a signal is located at the output of block 10, and to see whether the relays of the first safety logic path 1 are closed and whether the relays of the second safety logic path 2 are open, as well as to check whether all safety AND gates are activated and whether all second safety logic path 2 are turned off. If the above-mentioned conditions have been met, the safety logic path 1 in block 76 is deactivated and the task CPU activated is started in block 78, as illustrated in block 14 and in FIG. 5.

Subsequently, it is queried in block 80 whether all safety-related first safety logic paths 1, i.e., the first safety logic path 1 of each safety-related device, are turned off. If this is not the case, the task CPU activated is stopped (see FIG. 2b2). The same action is taken if the conditions of blocks 84, 88, 92, and 96 have not been met. In the opposite case, the monoflop, the Watchdog, is checked for functionality in block 84; a test is conducted in block 88 to see whether all second safety logic paths 2 are turned on; a test is conducted in block 92 to see whether the relay in the first safety logic path 1 is open and whether the relay in the second safety logic path 2 is closed, and, in block 96, a test is conducted to see whether the FPGA logic gates of the motor have been reset or not. If all the above-mentioned conditions have been met, the crosscheck and the plausibility check task is started in block 100 according to FIG. 2b1, as illustrated in FIG. 2d. To this end, block 18 sends a starting signal to block 20.

The self-test is continued in FIG. 2c. In block 102, a test is conducted to see whether the crosscheck and the plausibility check task has been successfully started. If this task has not been started, the block 14 CPU activated is stopped; otherwise the third task is started in block 16, the test of the safety hardware (HW-safety test) according to FIGS. 4a and 4b. Following the start command, the third task is checked to see whether the third task has been successfully started. If such is not the case, the CPU activated task is stopped. Otherwise, the software to control the printing press is started.

The task of block 20 according to FIG. 1 is described below, whose program run is illustrated in FIG. 3. Block 20 controls the first safety logic path 1. Following the closing of the doors or flaps of the printing press, the lockout function of block 20 is executed, whereby a confirmation of the lockout is required from the printing press operator. First, an initialization takes place in block 122. The cross-check and plausibility check is a closed loop; when the conditions of blocks 124, 126, 128, 130, 132, 134, 136, and 138 have been met, these blocks are checked successively; for every condition that has not been met, a signal is sent to block 135 with blocks 140, 142, 144, and 146, in which an IRQ interrupt command safety signal is initially generated, an interrupt command to interrupt the program run.

In response to the interrupt command, the operator receives an error message, which is indicated on a display of the device for controlling the printing press. The error is cleared, all three safety tasks are stopped and the operator confirms the further operation of the printing press. The stopping of the CPU activated task opens the second safety logic path 2, because the monoflop (Watchdog) is not triggered again. The crosscheck and plausibility check checks the logic behavior between the first safety logic path 1 and the second safety logic path 2. A test is conducted in Block 124 according to FIG. 3 to see whether the supply voltage to the safety switches SSW is properly applied. If such is the case, a test is conducted in block 126 to see whether the input signals of the first safety switch 11 (SSW 1) and the second safety switch (SSW 2) are identical. The first safety switch 11 (SSW 1) leads to a first safety logic path 1 and the second safety switch (SSW 2) leads to a second safety logic path 2. In block 130, the AND gates of the first safety logic path 1 are compared with the corresponding AND gates of the second safety logic path 2. If they are identical, a plausibility check is conducted in 132, in which the signal to the respective safety logic paths 1, 2 is calculated by using the input signals of the safety switches. If plausibility has been achieved, the calculated signal to the respective safety logic paths 1, 2 is identical to the signal in each safety logic path 1, 2.

In block 134, the input of the monoflop (Watchdog) for the second safety logic path 2 is checked to ensure that the CPU activated task and the monoflop are operating properly. A test is conducted in block 136 to see whether the first safety logic path 1 is working, in which the information about the latch-up protection and the data in the registers of the safety logic circuits 10, 12 are checked, whereby the registers are connected with the inputs of the AND gates. If these three conditions have been met, a test is finally conducted in block 138 to see whether the status in the second safety logic path 2 is identical to the status of the corresponding register content of the safety logic circuits 10, 12.

The third task according to block 16 is illustrated in the program scan flow chart according to FIG. 4a and FIG. 4b. First, an initialization takes place in block 148. The HW safety test represents a closed loop and detects errors in components of the electronic safety loop, which turns off the safety-related devices of the printing press, e.g., the FPGA of the motor, the AND gates for interruption and the relays of a step-by-step motor. The signal for starting the first block 150 comes from the last block 182 of this task. A test is conducted in block 150 to see whether the supply voltage is correctly properly applied to the safety switches. If such is not the case, block 155 is controlled with blocks 164, 166, 168, 169, and 170. At this point, a safety IRQ (interrupt command) is generated and an interruption or interrupt command of the program run is issued; an error message is indicated on a display of the printing press and the error is cleared, all three tasks or safety tasks are stopped, and lastly, confirmation is received from the printing press operator. Likewise, if the conditions of blocks 152, 154, 156, 158, 160, 162, 174, 176, 178, 180, and 182 have not met, they lead to the execution of block 155. Otherwise, a test is conducted in block 152 to see whether the circuit supply voltage Vcc has been applied and to see whether the status of the first safety switch 11 (SSW 1) in block 154 is identical to the status of the second safety switch (SSW 2), and a test is conducted in block 156 to see whether all motor-related safety switches SSW are closed. If all motor-related safety switches SSW are not closed, the FPGA's of the motor are reset and the program run continues with block 160. Otherwise, a test is conducted to see whether the FPGA's of the motor have not been reset or whether its memory has not been cleared, and a test is conducted in block 160, to see whether the status of the first safety switch II is identical to the status of the second safety switch. In block 162, it is determined whether a signal is at the output of the AND gate, i.e., whether all the safety switches of the electronic circuit are closed.

The program run continues in FIG. 4b. If all locking devices in block 174 are turned off, i.e., the printing press is operational, it is queried in block 176 whether all the AND gates of the FPGA's have been activated. Otherwise, the process is continued with block 180. A comparison is made in block 178 to see whether the switching condition of the relays of the first safety logic path 1 are identical to the switching condition of the relays of the second safety logic path 2. The relays are inspected, whereby the conditions of their operational verification contacts are read. Subsequently, a test is conducted in block 180 to see whether the relays of the first safety logic path 1 are functional and whether the safety logic path 1 is activated.

FIG. 5 shows a program scan flow chart of the third CPU activated task of block 14, which contains blocks 184, 186, 188, and 190. During this task, an initialization in block 184 is executed. Following a time delay of 00 ms in block 190, it is decided in block 186 whether to continue with the task or to stop it. Subsequently, the monoflop (Watchdog) is triggered in block 188. The task according to FIG. 5 controls the second safety logic path 2. FIG. 6 shows a circuit diagram of an embodiment of a branch of the electronic safety loop for energizing a motor of a printing press. It should be noted that only one switch for switching a device of the printing press is illustrated in FIG. 6, other switches are provided for other safety-related devices of the printing press. In this instance, the switching of the device, which in this case is a motor 16, is not executed by relays, but by turning off the motor phases. To this end, the safety voltage 7 feeds a voltage of 24 V into the switch and the 4′, 4″ in the voltage transformers is changed to 5 V, which is fed into the first safety logic circuit 10 and the second safety logic circuit 12. As a result, the first safety logic circuit 10 and the second safety logic circuit 12 each have a voltage supply 4′ and 4″, respectively. The first safety logic circuit 10 and the second safety logic circuit 12 each have arrangements of AND gates, with one AND gate per safety logic paths 1, 2, respectively, of which only the first safety logic path 1 and the second safety logic path 2 are depicted; other safety logic paths are provided for other safety-related devices. The output of the first safety logic circuit 10 is designated as safety logic path 1 and the output of the second safety logic circuit 12 is designated as safety logic path 2. The second safety logic path 2 leads to a NOR reset input of a signal generator 14. The output of the first safety logic circuit 10 is connected with the inputs of the first AND gate 13′ and to a second AND gate 13″. In addition, the inputs of the AND gates 13′, 13″ are connected to the output of a signal generator 14 for energizing the motor 16. The outputs of the AND gates 13′, 13″ are connected via an amplifier 15 with the motor 16 to be switched. The first safety logic path 1 inhibits the input signals to the motor 16, while the second safety logic path 2 inhibits the generation of phase signals in the signal generator 14 for driving the motor 16. The turning off of the motor 16 as a safety precaution is achieved by redundancy of the first safety logic path 1 and the second safety logic path 2. The electronic safety loop described above is operated in such a way that any error that occurs, e.g., an erroneous switching condition, does not lead to erroneous switching results in the safety-related devices to be switched. This means that even if an error occurs in the safety loop, the safety-related device concerned is securely turned off during the opening of the housing of the printing press.

The invention has been described in detail with particular reference to certain preferred embodiments thereof, but it will be understood that variations and modifications can be effected within the spirit and scope of the invention.

What is claimed is:

1. Electronic safety loop for the switching of safety-related devices of a printing press, characterized by several safety switches (11) for selective switching of the safety-related devices of the printing press as a function of the respective accessibility of the safety-related devices near an open or partially opened housing of the printing press, each of said safety switches (11) are connected with two independently operated signal lines or safety logic paths (1,2).

2. Electronic safety loop according to claim 1, characterized in that the safety switches are arranged on the flaps or doors of the printing press and can be activated by the opening and closing of the flaps or doors.

3. Electronic safety loop according to claim 2, characterized in that the proper function of the electronic safety loop can be automatically tested in a self-test.
